(19) United States
(12) Patent Application Publication
(10) Pub. No.: US 2022/0411717 A1
(43) Pub. Date: Dec. 29, 2022

(54) Timed Candle Wick System

(71) Applicant: William Conoly, Houston, TX (US)

(72) Inventor: William Conoly, Houston, TX (US)

(21) Appl. No.: 17/361,177

(22) Filed: Jun. 28, 2021

(51) Int. Cl. C11C 5/00

(52) U.S. Cl. CPC C11C 5/006

(57) ABSTRACT

A timed candle wick system which causes the flame of a candle to self-extinguish at predetermined periods of time. As part of the burning process, a new candle wick is automatically exposed prior to the extinguishment of the previous candle wick. Upon extinguishment of the previous candle wick, the newly exposed candle wick is ready to be relit without any other intervention by the user. The extinguishment of each wick is affected by an automatic, mechanical tumbling process that causes the wick to fall into the molten wax, depriving the flame of oxygen and extinguishing the candle. The wick rejuvenation process is affected by aligning two or more series of wicks, side-by-side, such that each wick segment of each wick series is overlapping a corresponding wick segment parallel to it, but is offset such as to maintain continuity of the wick burning process.

### CROSS REFERENCE TO RELATED APPLICATIONS

There have been many attempts at manipulating the burning of a candle or candle wick in a manner that self extinguishes the flame or otherwise makes the candle safer. However, no prior art utilizes the same methods and designs present in the current invention. Further as a benefit of these design differences, no prior art achieves the functionality and ease of manufacture benefits that the current invention makes allowable. Below is a brief overview of relevant prior arts and notable critical differences between them and the current invention.

US20090233249A1—Self Extinguishing Candle. Operates by surrounding wick with fire suppressant layer intermittently between wax fuel layers. Fire suppressant layer denies access to wax fuel once flame reaches suppressant layer, causing flame to extinguish. Suppressant layer may be removed in order to allow access to new wax fuel layer. Method of Extinguishment: Denying wick access to wax fuel. Method of Relighting Candle: Manually remove suppressant layer to expose fresh wax fuel.

US20060292508A1—Self Extinguishing Candle. Operates by interrupting the wick's access to the wax fuel by inserting impermeable layers intermittently into wick itself, thereby preventing wick from being able to use capillary forces to draw up melted wax fuel. In this prior art, an impermeable layer may also include a gap in which the wicks are connected by a small fiber in order to maintain the structural integrity of the wick as the flame melts the wax towards the gap in each wick section (FIG. 4 in Prior Art). This is one of several critical distinctions between this prior art and the current invention. Namely, the current invention intentionally removes any structural support at the base of each wick section, ensuring wick segments are completely severed in order to allow the wick to tumble mechanically as the wax liquifies beneath the severed wick, which is critical to the functionality and ease of manufacture of the current invention. Another form of this prior art has two parallel rows of wicks separated intermittently by gaps in the wicks (FIG. 7 in Prior Art). There are 4 critical distinctions between this form of the prior art and the current invention that critically impact functionality and ease of manufacture. The first is that in this prior art a significant gap is placed between the various severed segments of each column or series of wicks; whereas, although the current invention relies on severed wicks, it intentionally places no gap between those severed wicks as a critical component of the functionality of the invention. A gap would cause the current invention to fail to be relightable by pushing the wick segment beneath the gap beyond the zone in which the wax level drops during the burning of the preceding wick segment and cause the remaining wick segments to be out of sync in the same manner. Secondly, the Prior Art requires prefabricating special wicks encased in wax in order to place strategically within a candle container prior to wax being poured into the candle container. The Prior Art contemplates inserts separate wax encased wicks in a left right stair step pattern. The current invention has one continuous column of severed wicks that are stacked directly on top of each other to give the effect of a continuous wick with severed locations periodically. The current invention allows for regular wax wicks to be modified by severing them at specified lengths and then inserting them without further modification into pre-poured wax candles. This allows for any wick manufacturers wick to be used and placed into any candle manufacturers candle after the normal manufacture process is complete for both wick and candle. Additionally, intentionally not placing a gap between the severed wick segments allows for easier and less costly implantation of the wick, requiring merely drilling or otherwise boring into the solid wax and inserting the various wick segments back to back into the candle. The third critical distinction is that all forms of this Prior Art rely on the wick burning to completeness in order to properly function and expose the subsequent wick section. The current invention specifically relies on the wick not burning to completeness and instead relies on the wick tumbling due to mechanical instability once the melted wax reaches the base of the severed portion of each wick section. The fourth and final critical distinction is that all forms of this Prior Art rely on removing the fuel source from the flame by disrupting the capillary action in the wick by way of an impermeable section in the wick. In some forms the impermeable section of the wick is the solid wax fuel itself, which is impermeable to liquefied wax. This is a critical difference compared to the current invention which at no time interrupts the capillary action of the wick or denies the wick access to liquified fuel. Instead, the current invention extinguishes the flame by denying oxygen to the flame at certain predetermined points in time during the burning process.

U.S. Pat. No. 7,578,670B2—Self Extinguishing Candle. Involves single continuous wick with portions of the wick covered by a “wick appliance” that has the effect of making the wick impermeable at the location of the appliance. The flame is snuffed out by the impermeability of the wick appliance denying wax fuel to the wick. The appliance is removed manually after the wick burns out, which reveals a fresh portion of the same continuous wick and allows for renewed permeable contact between the wax fuel and the wick. Method of Extinguishment: Denying wick access to wax fuel. Method of Relighting Candle: Manually remove suppressant tool to expose fresh wax fuel.

US20030124474A1—Self Extinguishing Candle. Incorporates flame retardant elements into wick. Method of Extinguishment: Denying wick access to wax fuel. Method of Relighting Candle: Unknown.

US20110076631A1—Self Extinguishing Candlewick. Continuous wick surrounded by non-flammable sleeves which snuff out the flame. Method of Extinguishment: Denying wick access to wax fuel. Method of Relighting Candle: Manually remove suppressant sleeves to expose fresh wax fuel.

US20040091829A1—Self Extinguishing Wick and Method of Producing the Same. Method of Extinguishment: Denying wick access to wax fuel via a combustion barrier. Method of Relighting Candle: Manually remove suppressant barrier and manually extract wick, or may not be possible to extract wick. In an alternate form of this prior art a wick directly beneath and in the longitudinal path of the previously burned wick is exposed at an angle in order to be subsequently lit. Beyond the obvious differences in this prior arts functionality and method of extinguishment compared to the current invention, it should be noted that an additional critical difference is that this prior art uses only one series of wicks in the longitudinal direction and requires each subsequent wick to be longer than the longitudinal path in which the wicks lie, requiring special manufacturing processes to incorporate the wick before the wax is poured into the candle holder. This is a disadvantage from the current invention, which may be incorporated after a candle is manufactured and in a separate facility if desired. Making retooling at the original manufactures facility unnecessary.

Various other prior arts exist that rely on some combination of 1) denying wick access to melted wax fuel, 2) using an accelerant or some other chemical to snuff out the candle flame, 3) using a mechanical device to reveal a new wick capable of being lit after the initial wick extinguishes, 4) require special manufacturing procedures during or before the candle or wick material is manufactured, and 5) use a mechanical device to deny the flame oxygen.

AU of the above methods differ critically from the current invention in function and effect. Importantly many of the characteristics incorporated in the above prior arts would in fact cause this invention to fail if they were used in this invention. Further, the design of this invention improves upon any of the prior arts existing by improving the reliability and functionality of the final timed candle wick system in addition to vastly simplifying the manufacture process and making the wick system easily applicable to all wick and candle manufacture types.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING CONMPACT DISC APPENDIX

Not Applicable

### BACKGROUND OF THE INVENTION

This invention relates to the field of candle and wick designs and their manufacture.

The consumer candle market has increased dramatically with time. Two problems that have persisted in the candle market despite developments in the candle making art are 1) the ability to make candles safer and prevent causing fires and 2) prevent forgetting a candle is lit and wasting the candles wax fuel. While there are some products on the market that help to accomplish these goals and they have some degree of commercial success, they are cumbersome and depart significantly from the traditional and classic look of a cylindrical open top candle and detract from the candles overall attractiveness.

### BRIEF SUMMARY OF THE INVENTION

This invention is designed to address 2 problems related to the burning of candles by consumers. The first is a desire by the consumer to protect their home or building from fire caused by the burning of a candle. The second is the desire by the consumer to be able to better manage the burning of their candle so as not to waste the candle by forgetting the candle is lit for an extended period of time. This invention is a wick system which allows the user to light the candle in the same manner as a traditional candle and after a predetermined period of time have the flame extinguish automatically. After the flame extinguishes, due to the configuration of several parallel wicks in the wick system, a new wick will have been exposed by the reduced wax level. This pattern will continue so that each wick burns for the predetermined period of time. The self extinguishing property of the candle wick system gives consumers peace of mind that if the candle is mistakenly left unattended, the chance of fire has been dramatically reduced by the significant reduction in time that the candle can burn unattended. Additionally, a consumer has the peace of mind that if the candle is mistakenly left unattended, it will not waste a significant portion of the candle. No unusual tasks or manual processes are required beyond the typical lighting of a candle that consumers are familiar with. In addition, the manufacture process is extremely simple and can be applied after a candle or wick is already manufactured.

The system consists of 2, 3, 4 or more parallel wicks which have been severed into segments. The segments are generally even but do not always need to be. The length of the segments is determined based on the desired incremental burn time of the candle. The wicks are offset from each other within the candle such that as a wick segment burns, it reveals the next wick segment to be lit by the time the previous wick self-extinguishes. This process continues until the wax system reaches the bottom of the candle and the wax fuel is used up.

### BRIEF DESCRIPTION OF THE SEVERAL VIEWS OF THE DRAWINGS

The detailed description of some of the embodiments of the invention is made below with reference to the accompanying figures, wherein like numerals represent corresponding parts of the figures.

FIG. 1 is a top-down perspective of the candle and wick system illustrating the location of the wicks looking down the longitudinal axis. In this embodiment there are 3 series of wicks; however, there may be as few as two and no limit to the max number of wick series that may be used.

FIG. 2 is a side cross sectional view of the candle and wick system illustrating the relative depth and offsetting nature of the wick system within the wax fuel matrix. It also shows the severed segments within each wick series. A series of wicks is a representation of a single wick that has been severed into segments to create a series of separate smaller wick segments within the series.

FIG. 3 is a representation of FIG. 2 after a predetermined amount of time has passed, during which the candle was burning and after which the first wick toppled over, extinguishing the flame.

FIG. 4 is a representation of FIG. 3 showing the subsequent toppling of the second wick after the candle was relit and a second predetermined amount of time had passed. The second wick has toppled over and extinguished. The third wick has been revealed due to the again decreased wax level.

FIG. 5 is a diagram of an individual wick segment within a wick series and illustrates the 3 labeled sections within the wick segment and their function to the invention. The Dry Wick Section is the portion of the wick that is revealed by the dropping wax level and is what is lit when the wick segment is ignited for the first time. The Timed Burn Section is the portion of the wick segment that is originally below the wax line before the wick segment is lit. The wax level will drop from the top of the Timed Burn Section to the bottom of the Timed Burn Section, after which point the wick segment will tumble over and extinguish. The Structural Support Section is the minimum portion of the wick segment that is required in order for the wick segment to maintain structural integrity and not tumble over. Once the wax level drops below the top of the Structural Support Section, the wick segment tumbles over due to lack of structural support.

FIG. 6 is a diagram illustrating the functionality of the wick system in this invention. It illustrates the progression from one wick segment to the next, as the candle burns and the wax level drops. The arrows within the diagram represent the transition from one wick segment to the next at the indicated wax level. The transition is preceded by the toppling of the wick at the beginning of the arrows path and is completed by the manual lighting of the next wick at the end of the arrows path.

### DETAILED DESCRIPTION OF THE INVENTION

In the following detailed description of the invention, numerous details, and examples of the invention are described. However, it will be clear and apparent to one skilled in the art that the invention is not limited to the embodiments set forth and that the invention can be adapted for any of several applications.

The device and wick system of the present disclosure may be used to create a self extinguishing candle in addition to automatically generating a new wick that may be relit without any additional steps for the user to follow than may apply to a traditional candle and wick. The wick system itself may be used in an abundance of applications and is not limited to this application. The wick system is intended to develop a method in which a wick, however it may be extinguished, may automatically generate a new wick to be lit by the user. In addition, this invention incorporates a method of extinguishing the flame that involves causing the wick to tumble into the molten wax pool and extinguish by removing oxygen from the flame.

The embodiment shown in this example of the invention includes the following elements:
1. Wax Matrix
2. Wick Series
3. Severed Wick Segments within each Wick Series

The above elements are listed not to limit the elements that may be incorporated into the invention and wick system, but rather to better describe this most basic version of the invention.

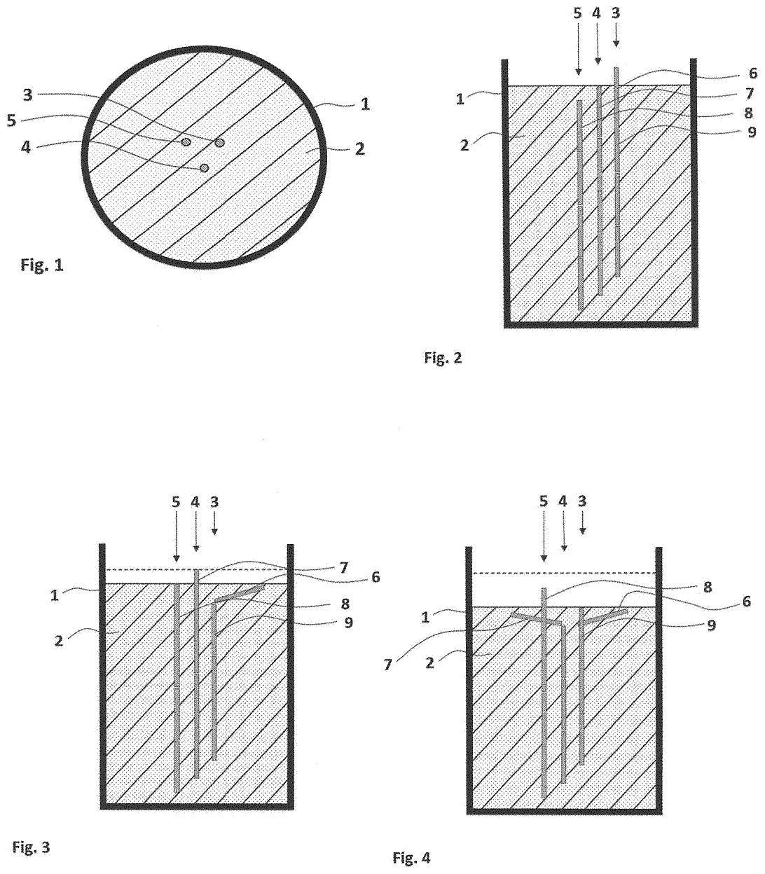

By way of example, referring to FIG. 1, three bores are created in a solid wax fuel matrix 2 that is typically encased in a container of some kind 1, with the container usually being made of glass. The bore depths are made such that the wick segments to be placed inside the bores will stack on top of each other and the aggregate length of the wicks will rise to a predetermined level near or above the wax matrix 1. The wick segments for each wick series 3,4,5 are then placed inside each bore, stacked one on top of the other and then pushed towards the bottom of the bore until the bottom wick segment within a wick series 3,4,5 is touching the bottom of the bore.

Referring to FIG. 2 the predetermined top of each wick series 3,4,5 will depend on the time desired for the wick to burn. In most instances, the tallest of the wick series 3 will need to protrude above the wax matrix layer enough to be able to be lit easily without modification by the user. In this embodiment, each subsequent wick series 4 and 5 will be deeper than wick series 1 by roughly ⅓ and ⅔ the length of an individual wick segment, respectively, to create an offset between the three wick series. Although, various alterations of the offset between the wick series may be made such that after a prior wick segment burns, it reduces the wax level and extinguishes the flame, while also revealing the next wick segment to be lit by the user. In this embodiment of the invention, the wick series 3,4,5 are severed completely at various points along the series in order to create physically separate wick segments 6-9 within the three wick series. However, it is possible that some other method may be used to create a distinction between the separately burning wick segments and still use this overlapping and offsetting multiple wick system for automatically regenerating a fresh wick upon the extinguishment of a prior wick. Although only wick segments 6-9 are labeled in this example, it can be seen that twelve distinct wick segments exist in FIG. 2, four wick segments for each of three wick series.

FIG. 3 shows the point in time after which wick segment 6 was lit, a predetermined period of burn time passed, the wax level dropped, and wick segment 6 tumbled into the wax pool extinguishing the flame. As a result of the wax matrix 2 level dropping, the upper portion of wick segment 4 has become exposed such that it may now be lit by the user. FIG. 4 shows the progression from wick series 4 to wick series 5 after wick segment 7 has burned to extinguishment, tumbled into the wax matrix 2, and the wax level has been reduced to reveal wick segment 8. After wick segment 8 is lit, it will burn to extinguishment and cause the wax level to drop and expose wick segment 9, which will restart the process back at wick series 3.

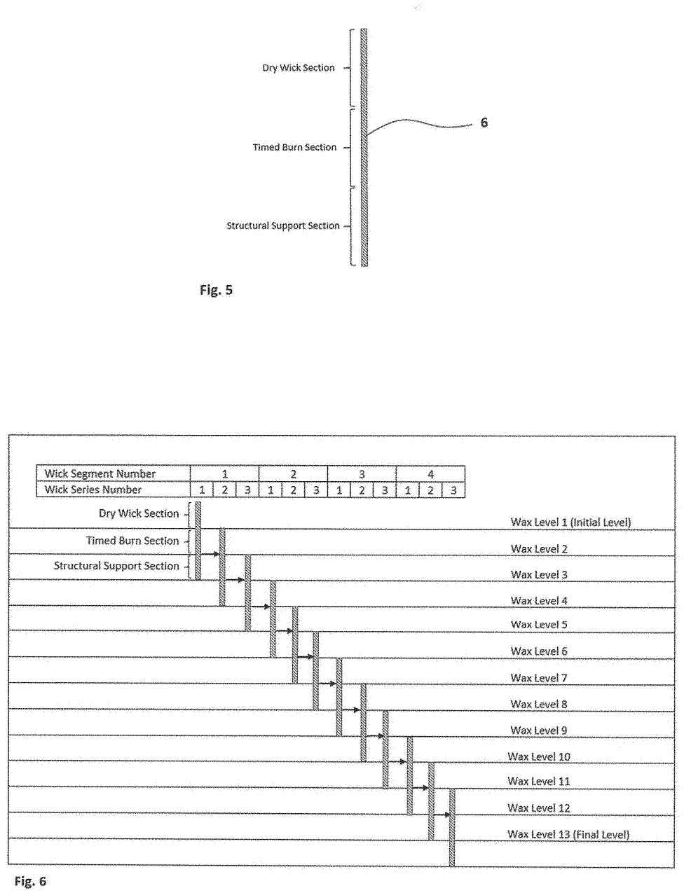

FIG. 5 is a diagram of an individual wick segment 6 within a wick series 3. The upper section of the wick segment called the “Dry Wick Section” functions as the portion that will be lit by the user. The mid section of the wick segment, called the “Timed Burn Section,” is the portion that will burn through time and whose length dictates the predetermined burn time of each wick segment 6-9. The bottom section or “Structural Support Section” functions as the trigger for extinguishment in this embodiment of the invention. When the wax level falls below the top of the “Structural Support Section” the wick becomes mechanically unstable and tumbles over into the molten wax, denying the wick of oxygen, and extinguishing the flame.

FIG. 6 is a diagram further illustrating the Timed Candle Wick Systems use of the overlapping and offsetting series of self extinguishing wick segments. It can be seen by the diagram that when each wick segment is lit and the wax level drops down to the bottom of the “Timed Burn Section”, the wick extinguishes, and the subsequent wick's “Dry Wick Section” is revealed. The arrows indicate not only the direction in which subsequent wick segments are lit, but also the wax level in which the transition takes place.

The wax matrix may be of any manufacture and the wick may be of any manufacture. Modest testing may be done between any new wax and wick pair in order to determine the desired length needed for each wick segment in order to achieve the desired amount of burn time for each segment.

A significant improvement of this invention is the simple manufacture process for implanting the Timed Candle Wick System into an existing unwicked wax matrix by drilling or otherwise forming a bore into a solid wax matrix to specified depths and then inserting the wick segments back to back until the bore is full and the bottom wick segment touches the bottom depth of the respective bore.

Persons of ordinary skill in the art may appreciate that numerous design configurations may be possible to enjoy the functional benefits of both the toppling method of extinguishment as well as the offsetting wick system which regenerates a fresh wick for lighting in this invention. Thus, given the wide variety of the configurations and arrangements of embodiments of the present invention the scope of the invention is reflected by the breadth of the claims below rather than narrowed by the embodiments described above.

What is claimed is:

1. A tumbling mechanism for extinguishing a candle flame. This is achieved by causing the wick to become mechanically unstable after a predetermined period of time. The instability of the wick causes the wick to tumble into the molten wax and extinguish the flame by depriving the flame of oxygen.

2. A Timed Candle Wick System in which a subsequent and offsetting wick segment becomes exposed after a previous wick segment burns the wax level down and exposes a subsequent wick segment, allowing the user to relight the candle without taking any further action besides lighting the newly exposed wick. This is achieved by offsetting a parallel series of wick segments in such a way that the portion of each wick segment intended to be lit is overlapping the portion of the previous wick segment enough to be substantially exposed by the falling wax level, but not so much that it leaves an insufficient portion of the remaining wick to be burned for a useful period of time to a consumer. Additionally, the series of wick segments must overlap in such a way that they are in sync from the standpoint that the process of exposing and relighting each subsequent wick segment may be done for all wick segments within the candle and without any additional steps taken by the user besides lighting the next wick in the same manner they would a traditional candle.
